(19) United States
(12) Patent Application Publication
(10) Pub. No.: US 2014/0173163 A1
(43) Pub. Date: Jun. 19, 2014

(54) INFORMATION PROCESSING APPARATUS, CONTROL METHOD OF INFORMATION PROCESSING APPARATUS AND APPARATUS

(71) Applicant: FUJITSU LIMITED, Kawasaki-shi (JP)

(72) Inventor: Yoshihiro KITAHARA, Kawasaki (JP)

(73) Assignee: FUJITSU LIMITED, Kawasaki-shi (JP)

(21) Appl. No.: 14/187,611

(22) Filed: Feb. 24, 2014

Related U.S. Application Data
(63) Continuation of application No. PCT/JP2011/004743, filed on Aug. 25, 2011.

(51) Int. Cl. G06F 13/40

(52) U.S. Cl. CPC G06F 13/4059; G06F 13/4022
USPC 710/310

(57) ABSTRACT

An information processing apparatus includes a first processor, a second processor, a switch configured to relay a packet transmitted between the first processor and the second processor, a first output buffer corresponding to the first processor and being configured to store therein a first packet from the first processor and being addressed to the second processor and received through the switch, a first input buffer corresponding to the first processor, and a first selector configured to select one of a first path and a second path, based on a free space of the first output buffer. When the first packet is input, the first path is configured to output the first packet from the first processor to the switch through the first input buffer and the second path is configured to output the first packet from the first processor to the switch not through the first input buffer.

### CROSS-REFERENCE TO RELATED APPLICATION

This application is a continuation application of International Application PCT/JP2011/004743, filed on Aug. 25, 2011, the entire contents of which are incorporated herein by reference.

### FIELD

The embodiments discussed herein are related to an information processing apparatus, a control method of an information processing apparatus and apparatus.

### BACKGROUND

In the past, there has been known an information processing apparatus coupling a plurality of nodes equipped with central processing units (CPUs), using a crossbar. In such an information processing apparatus, the crossbar includes a plurality of input/output (I/O) ports to which the individual nodes are coupled, and a data crossbar to which the individual I/O ports are coupled and which performs data exchange between the individual I/O ports. Each I/O port includes an input port for sending packets from a coupled node to the data crossbar, and an output port for transmitting packets sent from the data crossbar to a coupled node.

In many cases, the information processing apparatus including such a crossbar provides a buffer for temporarily holding packets in input ports or output ports, to which the individual nodes are coupled.

In addition, for example, as in Japanese Laid-open Patent Publication No. 11-232236, as a technique of the related art, there has been known an information processing apparatus that provides this buffer on the input port side of each I/O port of the crossbar and arbitrates the sequence of packet transfer between a plurality of nodes.

### SUMMARY

According to an aspect of the invention, an apparatus includes a first processor; a second processor; a switch configured to relay a packet transmitted between the first processor and the second processor; a first output buffer corresponding to the first processor, the first output buffer being configured to store therein a first packet from the first processor, the first packet being addressed to the second processor and received through the switch; a first input buffer corresponding to the first processor; and a first selector configured to select one of a first path and a second path, based on a free space of the first output buffer. The first path is configured to output the first packet from the first processor, addressed to the second processor, to the switch through the first input buffer when the first packet is input, and the second path is configured to output the first packet from the first processor, addressed to the second processor, to the switch not through the first input buffer when the first packet is input.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an outline of a configuration of an information processing apparatus in the present embodiment;

FIG. 2 is an explanatory diagram of a crossbar in the present embodiment;

FIG. 3 is a diagram illustrating a configuration of an input port in the present embodiment;

FIG. 4 is a diagram illustrating a configuration of a buffer in the present embodiment;

FIG. 5 is a diagram illustrating a configuration of an output port in the present embodiment;

FIG. 6 is a diagram for explaining an operation of an input port in the present embodiment;

FIG. 7 is a diagram for explaining an operation of an input port in the present embodiment;

FIG. 8 is a sequence diagram illustrating processing when a packet has arrived at an input port in the present embodiment;

FIG. 9 is a sequence diagram for explaining an operation of an input port in the present embodiment;

FIG. 10 is a sequence diagram for explaining an operation of an input port in the present embodiment;

FIG. 11 is a diagram for explaining an operation of an input port in the present embodiment;

FIG. 12 is a sequence diagram for explaining an operation of an input port in the present embodiment;

FIG. 13 is a sequence diagram for explaining an operation of an input port in the present embodiment;

FIG. 14 is a sequence diagram for explaining an operation of an input port in the present embodiment; and

FIG. 15 is a diagram explaining a relationship between the number of output ports and a buffer reduction ratio in the present embodiment.

### DESCRIPTION OF EMBODIMENTS

In a case where, as the related art, a buffer is provided on each input port side of an information processing apparatus, each output port does not store therein a packet, and hence, transmits an output request for a packet, to the input port of another I/O port at a time when packet transmission to a coupled node has become possible. Accordingly, each output port transmits a packet transmitted from one of input ports in response to this request, to a coupled node. In other words, in a case where a buffer is provided on an input port side, in order to transfer data from the buffer to an output port side, communication is performed twice for a request from an output port and packet transfer from an input buffer.

On the other hand, in a case where a buffer is provided on each output port side of an information processing apparatus, it is difficult for an input port to save therein a packet, and hence, a packet the input port has received is transmitted to an output port without change. In other words, in a case where the buffer is provided on the output port side, a request from the output port is not desired as in a case where a buffer is provided in an input port, and the number of times communication is performed becomes smaller than in a case where the buffer is provided in the input port.

However, since, in many case, successive packets of a predetermined number from a node in an information processing apparatus become meaningful, it is desirable that buffers whose number corresponds to other individual input ports are provided in each output port. Therefore, in a case where a buffer is provided in an output port, the capacity of a desired buffer becomes larger than in a case where a buffer is provided in an input port.

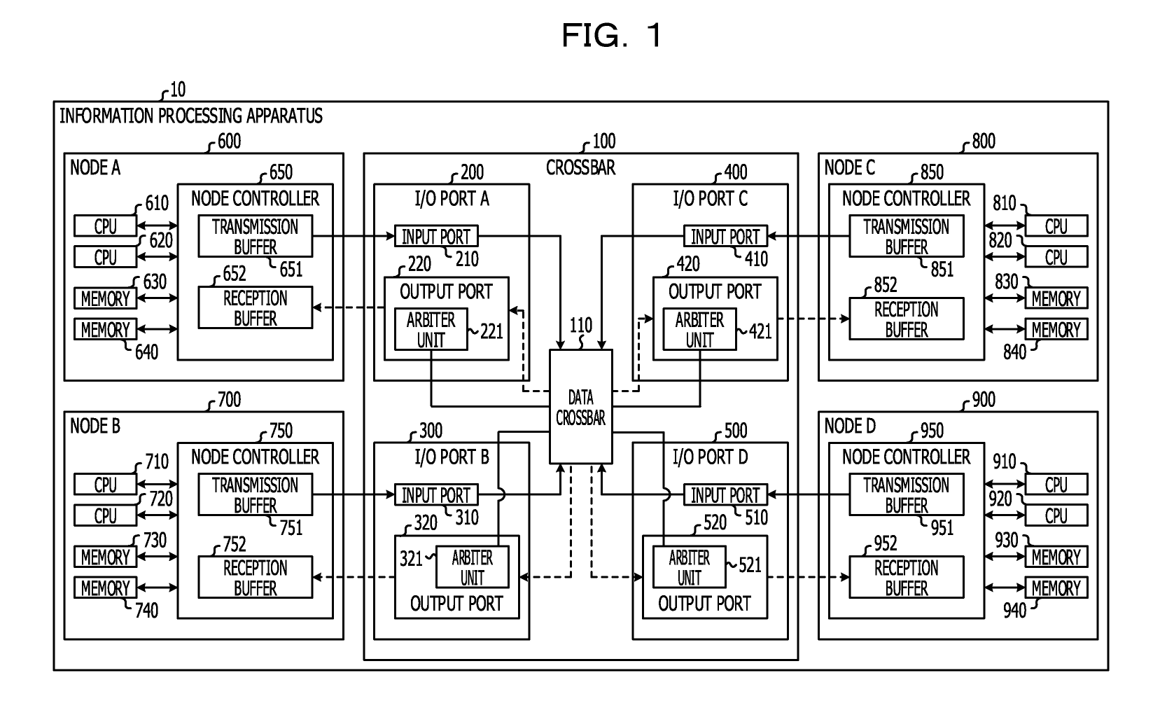

Hereinafter, the disclosed technology will be described in detail using drawings. FIG. 1 is a block diagram illustrating the outline of the configuration of an information processing apparatus in the present embodiment. As illustrated in FIG. 1, an information processing apparatus 10 includes a crossbar 100. This crossbar 100 includes an I/O port A 200, an I/O port B 300, an I/O port C 400, and, an I/O port D 500, to which a node A 600, a node B 700, a node C 800, and a node D 900 are coupled, respectively.

In addition, the individual I/O port A 200, I/O port B 300, I/O port C 400, and, I/O port D 500 are coupled to a data crossbar 110 within the crossbar 100.

Hereinafter, the node A 600 will be described. In addition, it is assumed that the node B 700, the node C 800, and the node D 900 have the same configuration as that of the node A 600, and the description thereof will be omitted.

In the node A 600, a CPU 610 and a CPU 620, which serve as a type of arithmetic processing unit, a memory 630, and a memory 640 are coupled to a node controller 650. The memory 630 and the memory 640 are storage units storing therein the results of operations performed by the CPU 610 and the CPU 620. In addition, the memory 630 and the memory 640 store therein packets transferred from the node B 700, the node C 800, and/or the node D 900.

The node controller 650 is a control circuit controlling the entire node A 600. This node controller 650 includes a reception buffer 652 and a transmission buffer 651 that store therein various kinds of packets transmitted and received between the crossbar 100 and the CPU 610 and CPU 620 or the memory 630 and memory 640.

The transmission buffer 651 is a buffer for temporarily storing therein various kinds of packets to be output from the CPU 610 and the CPU 620 to another node or I/O port. Packets temporarily stored in the transmission buffer 651 are transmitted to the input port 210 of an I/O port A 200 in the after-mentioned crossbar 100.

The reception buffer 652 temporarily stores therein a packet received from the after-mentioned crossbar 100. Packets temporarily stored in the reception buffer 652 are individually output to the CPU 610 and/or the CPU 620 and the memory 630 and the memory 640.

In addition, the number of nodes coupled to the crossbar 100 is not limited to four including the node A 600, the node B 700, the node C 800, and the node D 900, described above. In addition, while each node includes two CPUs and two memories, the respective numbers thereof are not limited to two, and each node may also include a functional unit other than the CPUs and the memories.

The crossbar 100 includes the data crossbar (corresponding to a crossbar switch) 110, the I/O port A 200, the I/O port B 300, the I/O port C 400, and the I/O port D 500.

The data crossbar 110 handles a routing of packets output from the individual I/O port A 200, I/O port B 300, I/O port C 400, and I/O port D 500 within the crossbar 100 with regard to the individual I/O port A 200, I/O port B 300, I/O port C 400, and I/O port D 500 indicated as a destination in each packet.

The I/O port A 200 includes the input port 210 and the output port 220. The input port 210 outputs, to the data crossbar 110, a packet received from the transmission buffer 651 in the node controller 650 in the node A 600.

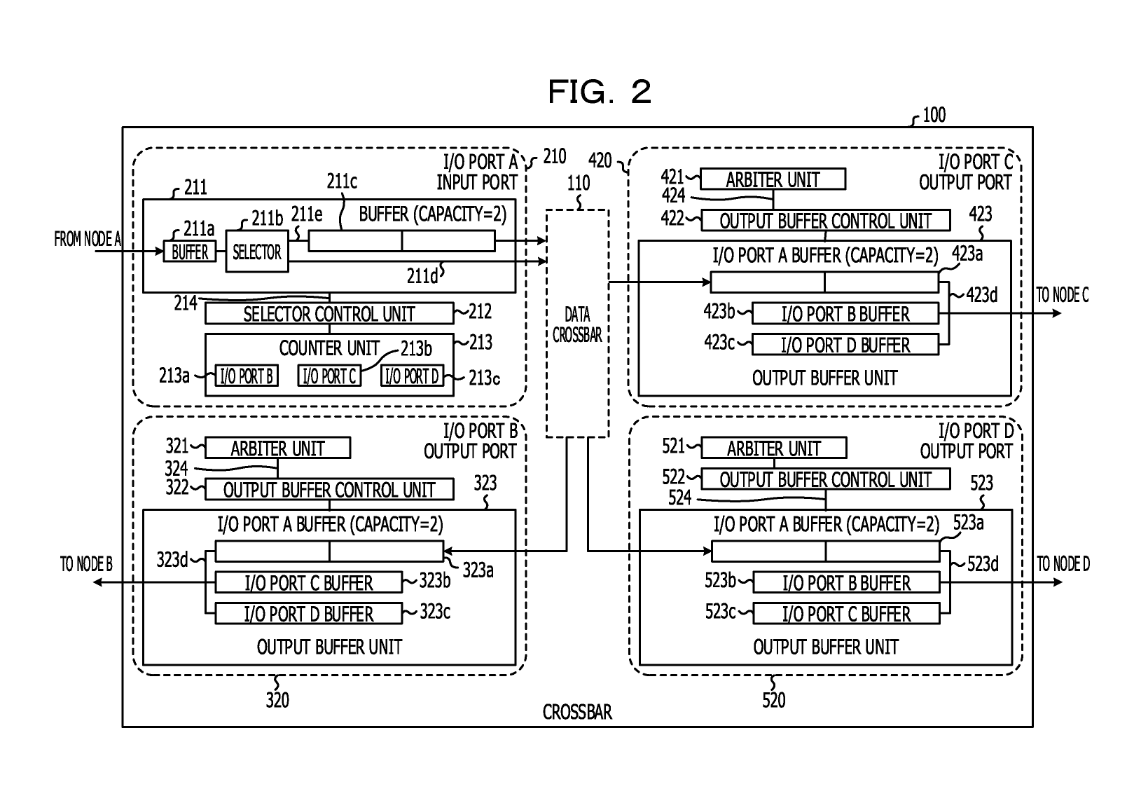

FIG. 2 is the explanatory diagram of the crossbar 100 in the present embodiment. In detail, FIG. 2 is a diagram where the data crossbar 110, the input port 210 in the I/O port A, and the output ports 320, 420, and 520 and the arbiter units 321, 421, and 521 in the I/O port B 300, the I/O port C 400, the I/O port D 500, respectively, are extracted from the configuration of the crossbar 100.

In addition, while not illustrated, the output port 220 in the I/O port A 200 has the same configuration as those of the other output ports 320, 420, and 520 in the present embodiment. In the same way, input ports 310, 410, and 510 in the I/O port B 300, I/O port C 400, and I/O port D 500 have the same configuration as that of the input port 210 in the I/O port A 200.

As illustrated in FIG. 2, the crossbar 100 includes the data crossbar 110, the input port 210 in the I/O port A 200, the output port 320 in the I/O port B 300, the output port 420 in the I/O port C 400, and the output port 520 in the I/O port D 500. In addition, the output port 320 in the I/O port B 300 has the same configuration as those of the output port 420 in the I/O port C 400 and the output port 520 in the I/O port D 500. A functional unit whose name coincides except for the symbol thereof has the same function and performs the same processing. In addition, in the present embodiment, the number of packet transmissions (the number of credits) able to be transmitted from the node A 600 to the node B 700, the node C 800, and the node D 900 is set to “4”.

The input port 210 includes an input buffer unit 211, a selector control unit 212, and a counter unit 213. The input buffer unit 211, the selector control unit 212, and the counter unit 213 are coupled to one another through a bus 214.

The input buffer unit 211 includes a buffer 211a, a selector 211b, a buffer 211c, a bypass path 211d, and a buffer bus 211e.

The buffer 211a temporarily stores therein a packet transmitted from the node A 600 to adjust timing between an instruction to the selector 211b and providing of the packet to the selector 211b. The packet in the buffer 211a is transmitted to the selector 211b after adjusting of the timing. The buffer 211a may not be provided in a case where the adjusting of the timing is not needed.

Based on an instruction from the selector control unit 212, the selector 211b transmits the packet transmitted from the buffer 211a with switching to the buffer 211c or the data crossbar 110.

The buffer 211c temporarily stores therein the packet transmitted from the selector 211b. The buffer 211c transmits the temporarily stored packet to the data crossbar 110. In addition, it is desirable that the capacity of the buffer 211c is less than or equal to the capacities of an I/O port A buffer 323a, an I/O port A buffer 423a, and an I/O port A buffer 523a. It is desirable that the buffer 211c has a capacity less than or equal to one-half of the number of packet transmissions able to be transmitted from the node A 600.

The bypass path 211d transmits the packet transmitted from the selector 211b, to the data crossbar 110.

The buffer bus 211e couples the selector 211b and the buffer 211c to each other. The packet transmitted from the selector 211b is transmitted to the buffer 211c through the buffer bus 211e.

By controlling the selector 211b, the selector control unit 212 switches the transmission destination of a packet transmitted from the node A 600 to the buffer 211c or the data crossbar 110.

The counter unit 213 includes an I/O port B counter 213a, an I/O port C counter 213b, and an I/O port D counter 213c.

The I/O port B counter 213a counts the number of packets waiting to be output to the node B 700 through the I/O port B 300, from among packets transmitted to the crossbar 100 through the input port 210. Based on an instruction from the selector control unit 212, the I/O port B counter 213a performs addition or subtraction of the number of packets.

The I/O port C counter 213b counts the number of packets waiting to be output to the node C 800 through the I/O port C 400, from among packets transmitted to the crossbar 100 through the input port 210. Based on an instruction from the selector control unit 212, the I/O port C counter 213b performs addition or subtraction of the number of packets.

The I/O port D counter 213c counts the number of packets waiting to be output to the node D 900 through the I/O port D 500, from among packets transmitted to the crossbar 100 through the input port 210. Based on an instruction from the selector control unit 212, the I/O port D counter 213c performs addition or subtraction of the number of packets.

The output port 320 includes the arbiter unit 321, an output buffer control unit 322, an output buffer unit 323, and a bus 324. The arbiter unit 321, the output buffer control unit 322, and the output buffer unit 323 are coupled to one another through the bus 324.

The arbiter unit 321 manages the number of packets able to be transmitted to the node B 700. The arbiter unit 321 confirms the number of packets able to be transmitted to the node B 700, the number of packets being stored in a counter not illustrated. In a case where the number of packets exist that is able to be transmitted to the node B 700, the arbiter unit 321 selects one request where a packet is to be transmitted to the node B 700, from an I/O port A buffer 323a, the I/O port C buffer 323b, and an I/O port D buffer 323c, acquired by the output buffer control unit 322. For example, in a case where packets are stored in the I/O port A buffer 323a and the I/O port D buffer 323c, a packet request made by the output buffer control unit 322 to the arbiter unit 321 is a packet request for “transmitting a packet from the I/O port A 200 or the I/O port D 500”. Here, “packet request” means a request relating to the transmission/reception of a packet.

The arbiter unit 321 arbitrates which port (the I/O port A 200 or the I/O port D 500) a packet is to be transmitted from, in the packet request for “transmitting a packet from the I/O port A 200 or the I/O port D 500”. In accordance with priority control such as a least recent used (LRU) algorithm or a round-robin algorithm, the arbiter unit 321 arbitrates packet requests relating to packet transmission from the I/O port A 200, the I/O port C 400, and the I/O port D 500. As the result of the arbitration, in a case where a packet request for “transmitting a packet from the I/O port A 200” has won the arbitration, the arbiter unit 321 notifies the I/O port A buffer 323a of the arbitration result through the output buffer control unit 322. Here, “win arbitration” means that a packet request acquires a right to perform an actual packet request in the arbitration between the arbiter unit 221, the arbiter unit 321, the arbiter unit 421, and the arbiter unit 521. Here, a packet request having won the arbitration turns out to be output from the data crossbar 110 to a port serving as a destination. On the other hand, “lose arbitration” means that a packet request has not been able to acquire a right to perform an actual packet request in the arbitration. In other words, a packet request having lost the arbitration is not output from the data crossbar 110 to a port serving as a destination.

When a packet has been transmitted from the I/O port A 200, the I/O port C 400, or the I/O port D 500 through the data crossbar 110, the output buffer control unit 322 issues an instruction to the corresponding I/O port A buffer 323a, I/O port C buffer 323b, or I/O port D buffer 323c in the output buffer unit 323 to store therein the packet. When a packet has been transmitted from the I/O port A 200, the I/O port C 400, or the I/O port D 500 through the data crossbar 110, the output buffer control unit 322 makes a packet request for the arbiter unit 321 to perform arbitration for packet transmission. Based on an arbitration result given notice of by the arbiter unit 321, the output buffer control unit 322 instructs one buffer out of the I/O port A buffer 323a, the I/O port C buffer 323b, and the I/O port D buffer 323c to transfer a packet, the one buffer corresponding to a packet request having won arbitration. The output buffer control unit 322 gives a return notice (credit return notice) of the number of packets able to be transmitted to the input port 210, the input port 410, and the input port 510 serving as ports having won arbitration.

The output buffer unit 323 includes the I/O port A buffer 323a, the I/O port C buffer 323b, the I/O port D buffer 323c, and a bus 323d. The I/O port A buffer 323a, the I/O port C buffer 323b, and the I/O port D buffer 323c are coupled to one another through the bus 323d.

The I/O port A buffer 323a temporarily stores therein a packet transmitted from the I/O port A 200. It is desirable that the I/O port A buffer 323a has a capacity greater than or equal to one-half of the number of packet transmissions able to be transmitted from the node A 600. The I/O port A buffer 323a transmits the temporarily stored packet to the node B 700 through the bus 323d.

The I/O port C buffer 323b temporarily stores therein a packet transmitted from the I/O port C 400. It is desirable that the I/O port C buffer 323b has a capacity greater than or equal to one-half of the number of packet transmissions able to be transmitted from the node C 800. The I/O port C buffer 323b transmits the temporarily stored packet to the node B 700 through the bus 323d.

The I/O port D buffer 323c temporarily stores therein a packet transmitted from the I/O port D 500. It is desirable that the I/O port D buffer 323c has a capacity greater than or equal to one-half of the number of packet transmissions able to be transmitted from the node D 900. The I/O port D buffer 323c transmits the temporarily stored packet to the node B 700 through the bus 323d.

The output port 420 includes the arbiter unit 421, an output buffer control unit 422, an output buffer unit 423, and a bus 424. The arbiter unit 421, the output buffer control unit 422, and the output buffer unit 423 are coupled to one another through the bus 424. In addition, in the present embodiment, it is assumed that a functional unit whose name coincides except for the symbol thereof has the same function as that of the functional unit in the output port 320 and performs the same processing.

The output port 520 includes the arbiter unit 521, an output buffer control unit 522, an output buffer unit 523, and a bus 524. The arbiter unit 521, the output buffer control unit 522, and the output buffer unit 523 are coupled to one another through the bus 524. In addition, in the present embodiment, it is assumed that a functional unit whose name coincides except for the symbol thereof has the same function as that of the functional unit in the output port 320 and performs the same processing.

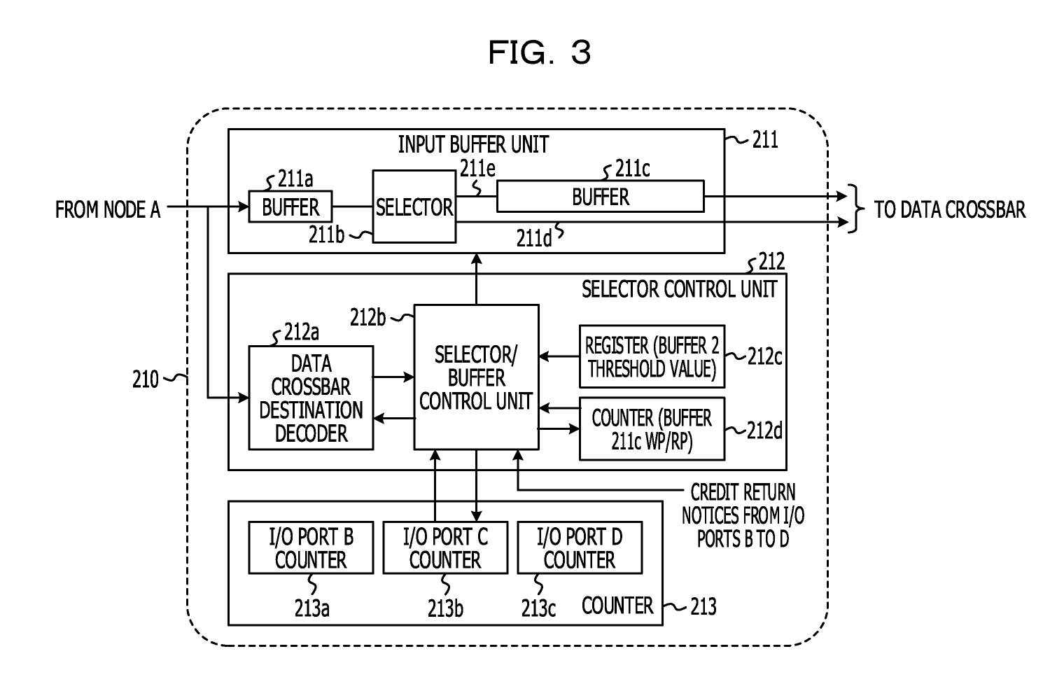

FIG. 3 is a diagram illustrating the configuration of the input port 210 in the present embodiment. In addition, in FIG. 3, the same symbol is assigned to the same configuration as the configuration described in FIG. 1 and FIG. 2, and the description thereof will be omitted.

The selector control unit 212 includes a data crossbar destination decoder 212a, a selector/buffer control unit 212b, a register 212c, and a counter 212d.

The data crossbar destination decoder 212a selects one output port from among the output port 320, the output port 420, and the output port 520 to serve as the transmission destination of a packet transmitted from the node A 600, and notifies the selector/buffer control unit 212b of the output port.

In the register 212c, the threshold values of capacities the I/O port A buffer 323a, the I/O port A buffer 423a, and the I/O port A buffer 523a have are stored. The threshold values of the capacities the I/O port A buffer 323a, the I/O port A buffer 423a, and the I/O port A buffer 523a have are preliminarily set. The register 212c continuously notifies the selector/buffer control unit 212b of the threshold values.

In a packet transmitted to the input port 210, the counter 212d stores therein the information of an address (writing pointer: WP) at the time of writing into the buffer 211c. The counter 212d stores therein the information of an address (reading pointer: RP) at the time of reading a packet from the buffer 211c. The counter 212d performs addition (+1) of the WP and the RP, based on an instruction from the selector/buffer control unit 212b.

Based on an output port notice from the data crossbar destination decoder 212a, the selector/buffer control unit 212b reads out the counter value of the buffer 211c from the counter 212d. In addition, the selector/buffer control unit 212b reads out a counter value from the I/O port B counter 213a, the I/O port C counter 213b, or the I/O port D counter 213c corresponding to one of the output port 320, the output port 420, and the output port 520 has and that has been given notice of by the output port notice from the data crossbar destination decoder 212a. The selector/buffer control unit 212b compares the read-out counter value with the threshold value notified by the register 212c.

In a case where the read-out counter value is greater than or equal to the threshold value notified by the register 212c, the selector/buffer control unit 212b issues an instruction to the selector 211b in the input buffer unit 211 to select the buffer bus 211e. In other words, the selector/buffer control unit 212b issues an instruction to the input buffer unit 211 to write a packet into the buffer 211c. An address in the buffer 211c where the packet is written according to the instruction is indicated by the value of the WP in the counter 212d. In addition, the selector/buffer control unit 212b issues an instruction to the counter 212d to perform addition (+1) of the value of the WP of the buffer 211c. The selector/buffer control unit 212b issues an instruction to the I/O port B counter 213a, the I/O port C counter 213b, or the I/O port D counter 213c in the counter unit 213 corresponding to an output port notified by the data crossbar destination decoder 212a to perform addition (+1) the value of the counter. In addition, a case where the read-out counter value is greater than or equal to the threshold value notified by the register 212c is a case where no capacity for temporarily storing a packet exists in the buffer (the I/O port A buffer 323a, the I/O port A buffer 423a, or the I/O port A buffer 523a) of the notified output port.

In addition, in a case where the read-out counter value is smaller than the threshold value notified by the register 212c, the selector/buffer control unit 212b issues an instruction to the selector 211b in the input buffer unit 211 to select the bypass path 211d. In addition, at this time, the selector/buffer control unit 212b issues an instruction to the I/O port B counter 213a, the I/O port C counter 213b, or the I/O port D counter 213c, which corresponds to output port notified by the data crossbar destination decoder 212a, to perform addition (+1) of the counter value. In addition, a case where the read-out counter value is smaller than the threshold value notified by the register 212c is a case where a capacity for temporarily storing a packet exists in the buffer (the I/O port A buffer 323a, the I/O port A buffer 423a, or the I/O port A buffer 523a) of the notified output port.

In addition to this, in a case where there is credit return notice from the output port 320, the output port 420, or the output port 520, the selector/buffer control unit 212b reads out the counter value of the I/O port B counter 213a, the I/O port C counter 213b, or the I/O port D counter 213c in the counter unit 213 corresponding to the output port 320, the output port 420, or the output port 520 which send the credit return notice. The selector/buffer control unit 212b compares the read-out counter value with the threshold value notified by the register 212c.

Furthermore, in a case where the read-out counter value is larger than the threshold value notified by the register 212c, the selector/buffer control unit 212b issues an instruction to the input buffer unit 211 to read out a packet stored in the buffer 211c. An address in the buffer 211c where the packet is read according to the instruction is indicated by the value of the RP in the counter 212d. The selector/buffer control unit 212b issues an instruction to the counter unit 213 to perform subtraction (−1) of counter value the I/O port B counter 213a, the I/O port C counter 213b, or the I/O port D counter 213c hold, the I/O port B counter 213a, the I/O port C counter 213b, or the I/O port D counter 213c corresponding to the output port 320, the output port 420, or the output port 520 which send the credit return notice. In addition, a case where the read-out counter value is larger than the threshold value notified by the register 212c is a case where a packet addressed to the output port which send the credit return notice among the output port 320, the output port 420, and the output port 520 has been temporarily stored in the buffer 211c.

In a case where the read-out counter value is less than or equal to the threshold value notified by the register 212c, the selector/buffer control unit 212b issues an instruction to the counter unit 213 to perform subtraction (−1) of counter value the I/O port B counter 213a, the I/O port C counter 213b, or the I/O port D counter 213c hold, the I/O port B counter 213a, the I/O port C counter 213b, or the I/O port D counter 213c corresponding to the output port 320, the output port 420, and the output port 520 which send the credit return notice. In addition, a case where the read-out counter value is less than or equal to the threshold value notified by the register 212c is a case where no packet addressed to the output port which send the credit return notice among the output port 320, the output port 420, and the output port 520 is temporarily stored in the buffer 211c.

The counter unit 213 includes the I/O port B counter 213a, the I/O port C counter 213b, and the I/O port D counter 213c, which correspond to output ports.

The I/O port B counter 213a corresponds to the I/O port B 300. The I/O port B counter 213a indicates the number where packets transmitted from the I/O node A 600 and to be output to the node B 700 are stored within the crossbar 100. The I/O port B counter 213a performs addition or subtraction of the counter value, based on an instruction from the selector control unit 212.

The I/O port C counter 213b corresponds to the I/O port C 400. The I/O port C counter 213b indicates the number where packets transmitted from the I/O node A 600 and to be output to the node C 800 are stored within the crossbar 100. The I/O port C counter 213b performs addition or subtraction of the counter value, based on an instruction from the selector control unit 212.

The I/O port D counter 213c corresponds to the I/O port D 500. The I/O port D counter 213c indicates the number where packets transmitted from the I/O node A 600 and to be output to the node D 900 are stored within the crossbar 100. The I/O port D counter 213c performs addition or subtraction of the counter value, based on an instruction from the selector control unit 212.

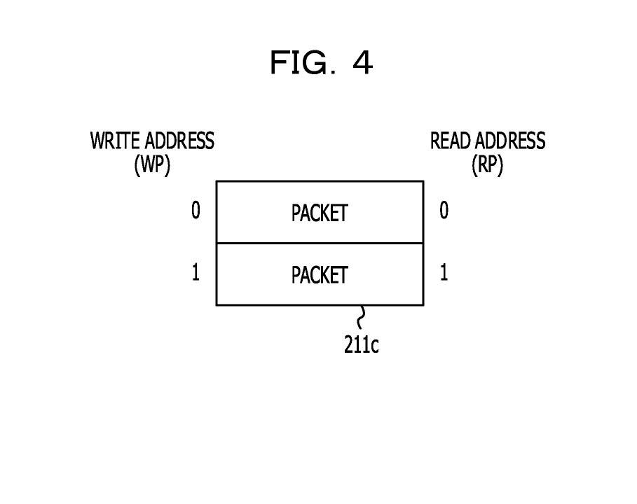

FIG. 4 is a diagram illustrating the configuration of the buffer 211c in the present embodiment. In addition, in FIG. 4, the same symbol is assigned to the same configuration as the configuration described in FIG. 1 to FIG. 3, and the description thereof will be omitted.

As illustrated in FIG. 4, the buffer 211c has a buffer structure capable of temporarily storing two packets. The buffer 211c has a first in first out (FIFO) structure. In the buffer 211c, writing of a packet is performed based on a write instruction from the selector/buffer control unit 212b with respect to a write address (write pointer: WP). In addition, in the buffer 211c, reading out of a packet is performed based on a read instruction from the selector/buffer control unit 212b with respect to a read address (read pointer: RP).

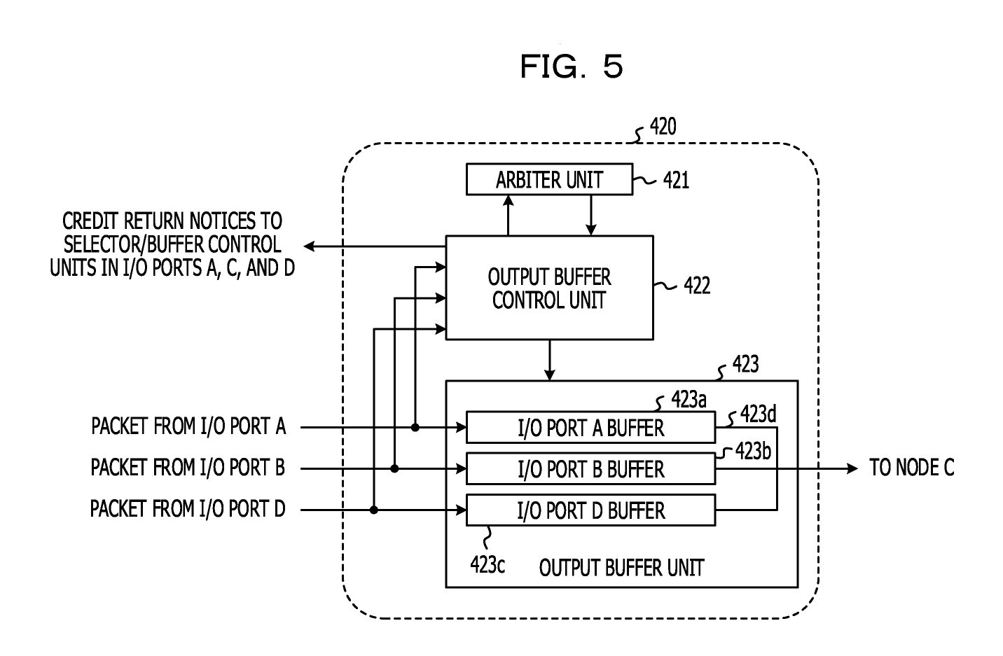

FIG. 5 is a diagram illustrating the configuration of the output port 420 in the present embodiment. In addition, in FIG. 5, the same symbol is assigned to the same configuration as the configuration described in FIG. 1 to FIG. 4, and the description thereof will be omitted.

When a packet has been transmitted from the I/O port A 200, the I/O port B 300, or the I/O port D 500 through the data crossbar 110, the output buffer control unit 422 issues an instruction to the corresponding I/O port A buffer 423a, I/O port B buffer 423b, or I/O port D buffer 423c in the output buffer unit 423 to write thereinto a packet. When a packet has been transmitted from the I/O port A 200, the I/O port B 300, or the I/O port D 500 through the data crossbar 110, the output buffer control unit 422 makes a packet request for the arbiter unit 421 to perform arbitration for packet transmission. Based on an arbitration result given notice of by the arbiter unit 421, the output buffer control unit 422 instructs one buffer out of the I/O port A buffer 423a, the I/O port B buffer 423b, and the I/O port D buffer 423c to read out a packet, the one buffer corresponding to a packet request having won arbitration. The output buffer control unit 422 gives a return notice of the number of packets able to be transmitted to the input port 210, the input port 310, and the input port 510 serving as ports having won arbitration.

When a packet has been stored in one buffer of the I/O port A buffer 423a, the I/O port B buffer 423b, and the I/O port D buffer 423c, the output buffer control unit 422 gives notice to the arbiter unit 421.

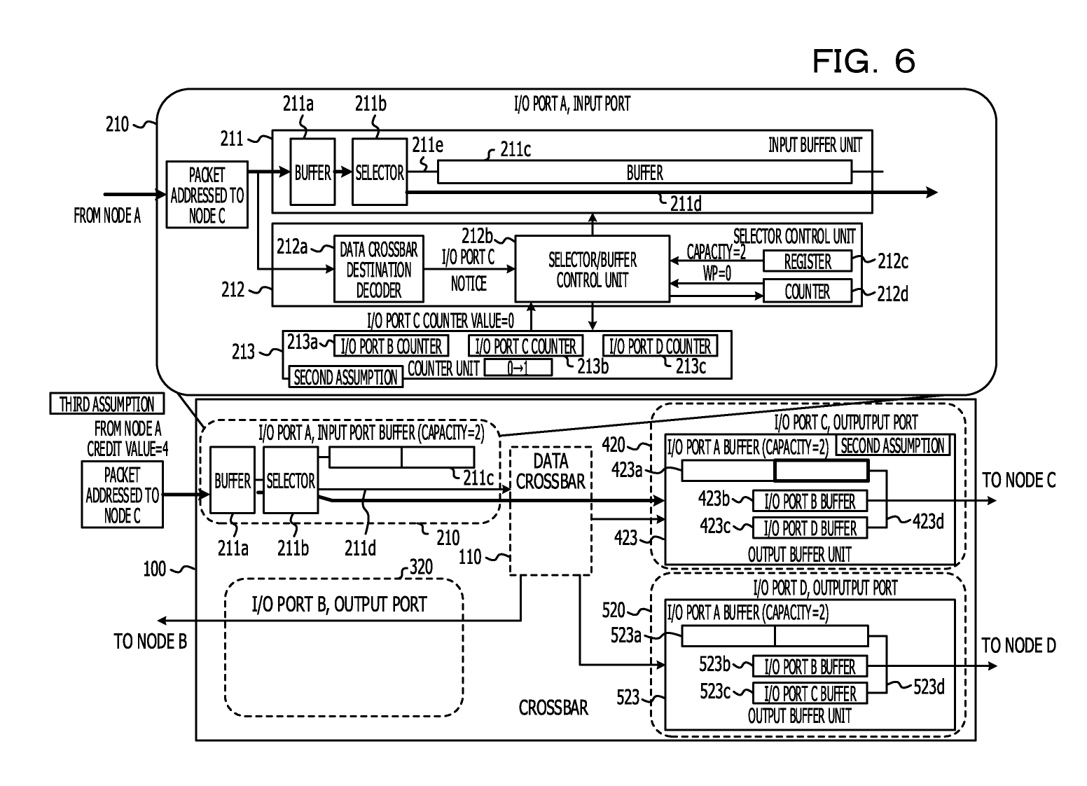

FIG. 6 is a diagram illustrating the operation of the input port 210 in the present embodiment. In addition, in FIG. 6, the same symbol is assigned to the same configuration as the configuration described in FIG. 1 to FIG. 5, and the description thereof will be omitted. FIG. 6 is a diagram for explaining an operation when a packet addressed to the node C 800 is transmitted from the node A 600 to the input port 210 in the I/O port A 200. In addition, in FIG. 6, it is assumed that no packets transmitted from the node A 600 remain within the crossbar 100. Therefore, there is a state which no packets from the node A 600 are stored in the buffer 211c in the input buffer unit 211, the I/O port A buffer 323a, the I/O port A buffer 423a, and the I/O port A buffer 523a. In addition, the number of packets (the number of credits) able to be transmitted from the node A 600 is “4” which is a maximum number because no packets remain within the crossbar 100.

As illustrated in FIG. 6, a packet addressed to the node C 800 is transmitted from the node A 600 to the input port 210 in the I/O port A 200.

Next, the data crossbar destination decoder 212a determines that the destination of the transmitted packet is the node C 800.

The data crossbar destination decoder 212a notifies the selector/buffer control unit 212b that the packet addressed to the node C 800 has been transmitted to the input port 210 in the I/O port A 200.

In addition, the selector/buffer control unit 212b compares the threshold value, “2”, of the capacity of the I/O port A buffer 423a notified by the register 212c with the counter value, “0”, received from the I/O port C counter 213b.

Next, from this comparison result, the selector/buffer control unit 212b determines that the counter value of the I/O port C counter 213b is smaller than the threshold value of the capacity of the I/O port A buffer 423a notified by the register 212c. In other words, the selector/buffer control unit 212b determines that there is a free space in the I/O port A buffer 423a in the output port 420.

In addition, the selector/buffer control unit 212b issues an instruction to the I/O port C counter 213b to perform addition (+1) of the counter value, the I/O port C counter 213b corresponding to the output port of the counter unit 213 given notice of. In addition, the selector/buffer control unit 212b issues an instruction to the selector 211b in the input buffer unit 211 to select the bypass path 211d and transmit a packet.

Based on the instruction from the selector/buffer control unit 212b, the counter unit 213 performs addition (+1) of the I/O port C counter 213b. Thereby, the counter value of the I/O port C counter 213b is changed “0” into “1”. This means that one packet addressed to the node C 800 and from the node A 600 remains within the crossbar 100.

In addition, based on the instruction from the selector/buffer control unit 212b, the selector 211b transmits the packet transmitted from the buffer 211a, with switching to the bypass path 211d. The transmitted packet is transmitted to the output port 420 in the I/O port 400 through the bypass path 211d and the data crossbar 110 and then is stored in the I/O port A buffer 423a.

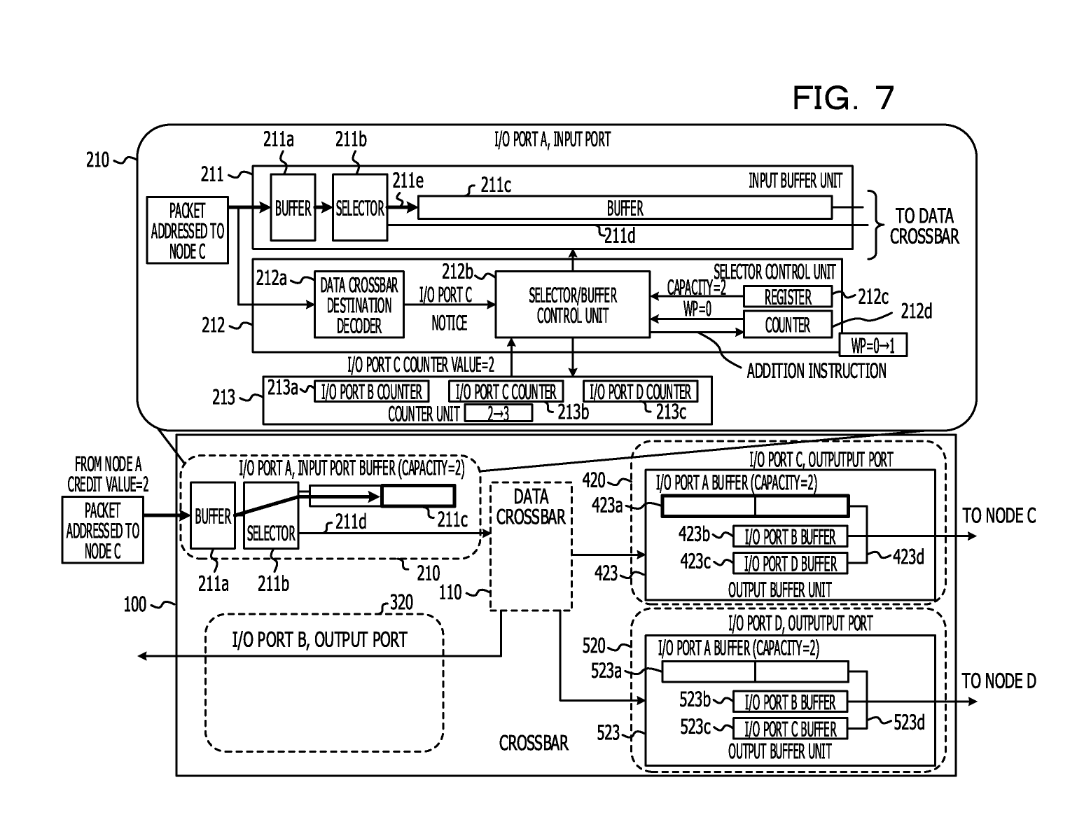

FIG. 7 is a diagram illustrating the operation of the input port 210 in the present embodiment. In addition, in FIG. 7, the same symbol is assigned to the same configuration as the configuration described in FIG. 1 to FIG. 6, and the description thereof will be omitted. FIG. 7 is a diagram for explaining an operation when a packet addressed to the node C 800 is transmitted from the node A 600 to the input port 210 in the I/O port A 200. In FIG. 7, two packets transmitted from the node A 600 are stored in the I/O port A buffer 423a. In other words, it is assumed that there is no free space for storing a packet, in the I/O port A buffer 423a. In addition, the number of packets (the number of credits) able to be transmitted from the node A 600 is “2” because two packets is already stored in the I/O port A buffer 423a though the maximum number of packets (the number of credits) able to be transmitted from the node A 600 is “4”.

As illustrated in FIG. 7, a packet addressed to the node C 800 is transmitted to the input port 210 in the I/O port A 200.

Next, the data crossbar destination decoder 212a determines that the destination of the transmitted packet is the node C 800.

The data crossbar destination decoder 212a notifies the selector/buffer control unit 212b that the packet addressed to the node C 800 has been transmitted to the input port 210 in the I/O port A 200.

The selector/buffer control unit 212b inquires of the register 212c about the threshold value of the I/O port A buffer 423a in the output port 420. The selector/buffer control unit 212b receives, from the register 212c, the threshold value, “2”, of the capacity of the I/O port A buffer 423a.

The selector/buffer control unit 212b inquires of the I/O port C counter 213b about the number of packets waiting to be output to the node C 800.

The selector/buffer control unit 212b compares the threshold value of the capacity of the I/O port A buffer 423a with the counter value, “2”, received from the I/O port C counter 213b.

As the result of this comparison, in a case where the counter value of the I/O port C counter 213b is greater than or equal to the threshold value of the capacity of the I/O port A buffer 423a notified by the register 212c, the selector/buffer control unit 212b determines that there is no free space in the I/O port A buffer 423a in the output port 420.

In addition, as the result of the comparison, in a case where the counter value of the I/O port C counter 213b is greater than or equal to the threshold value of the capacity of the I/O port A buffer 423a notified by the register 212c, the selector/buffer control unit 212b issues an instruction to the counter 212d to perform addition (+1) of the value of the WP so as to indicate that only one packet has been temporarily stored in the buffer 211c. In a case where the value of the WP of the counter 212d is “0”, the selector/buffer control unit 212b issues an instruction to the buffer 211c to write a packet into an address in the buffer 211c indicated by the WP of the counter 212d. The selector/buffer control unit 212b issues an instruction to the I/O port C counter 213b to perform addition (+1) of the counter value, the I/O port C counter 213b corresponding to the output port of the counter unit 213 given notice of.

Based on the instruction from the selector/buffer control unit 212b, the counter unit 213 performs addition (+1) processing for the I/O port C counter 213b. Thereby, the counter value of the I/O port C counter 213b changed “2” into “3”. This means that three packets addressed to the node C 800 and from the node A 600 remain within the crossbar 100.

Based on an instruction from the selector/buffer control unit 212b, the selector 211b temporarily stores a packet transmitted from the buffer 211a, in the buffer 211c through the buffer bus 211e. The buffer 211c temporarily stores the packet at an address where the value of the WP is “0”.

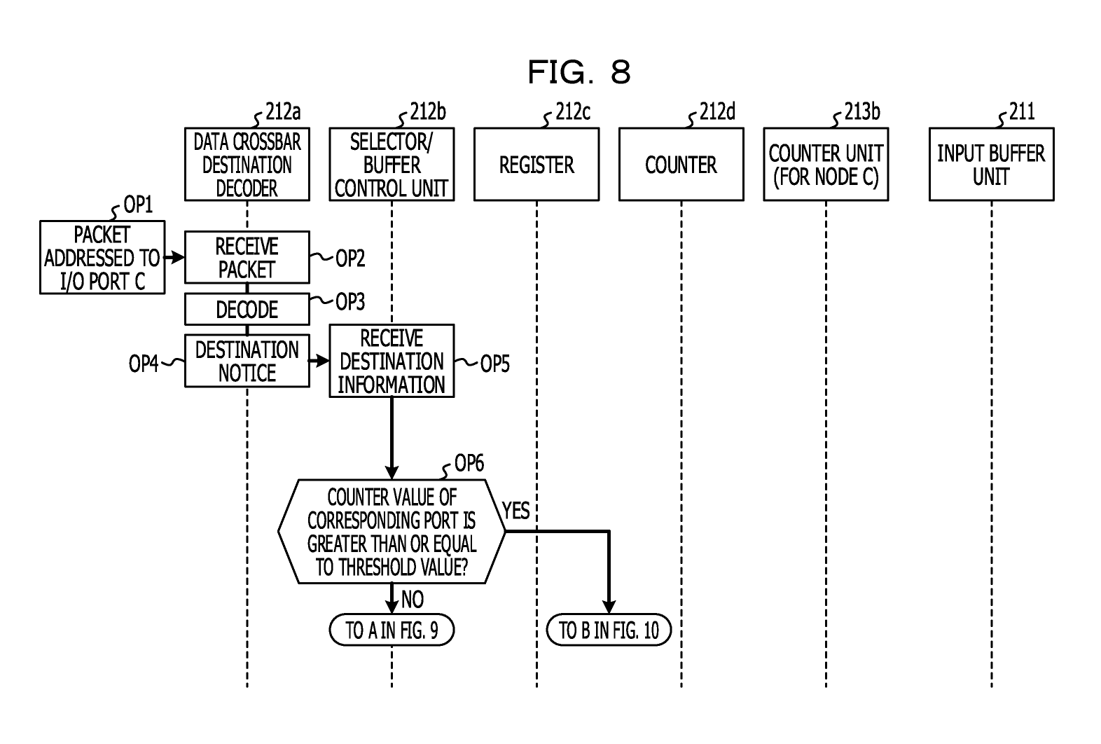

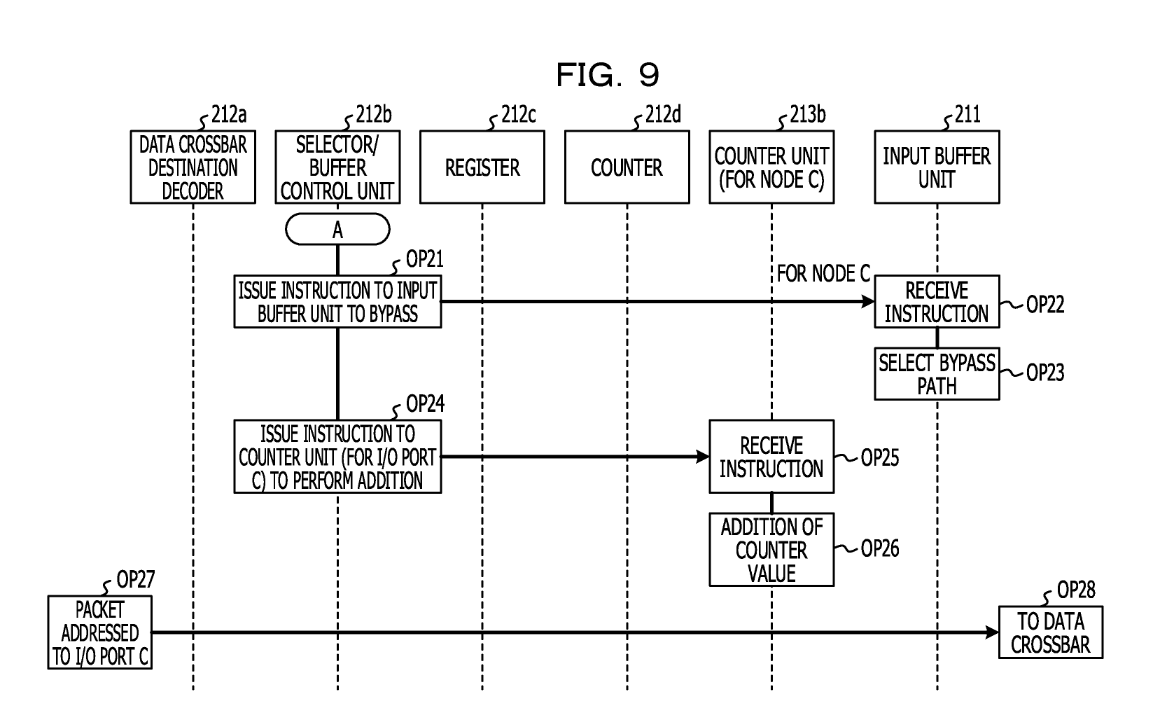

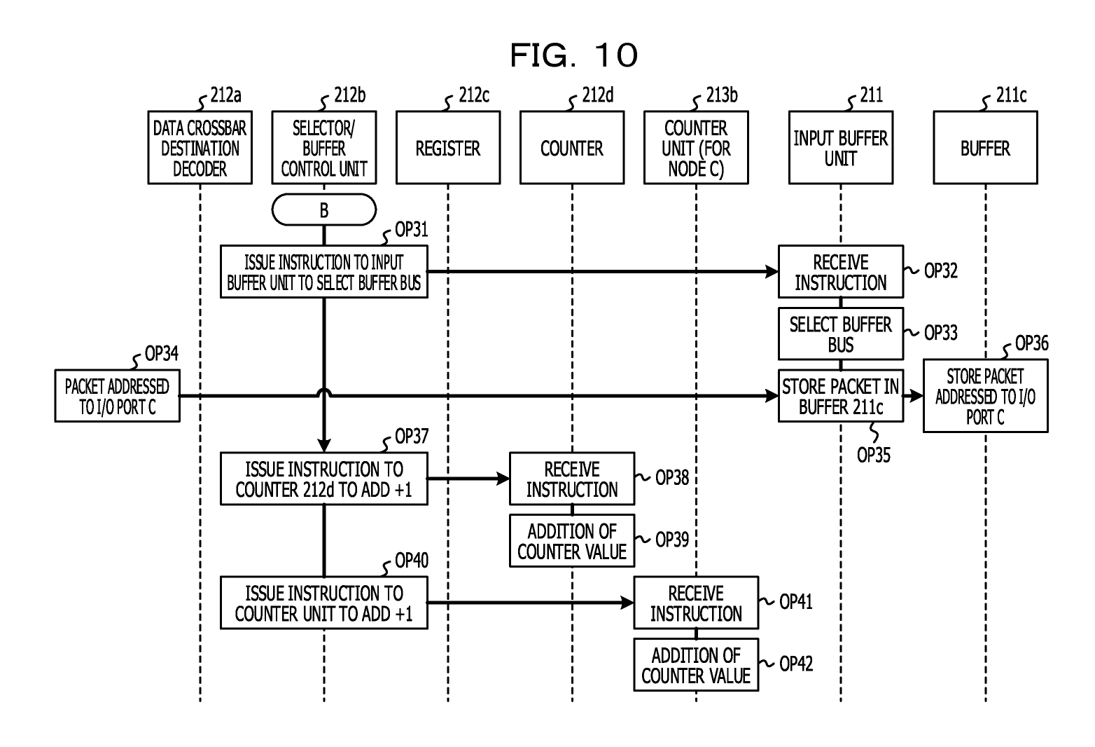

FIG. 8 to FIG. 10 are sequence diagrams for explaining the operation of the input port 210 in the present embodiment. Processing illustrated in A in FIG. 8 is followed by A in FIG. 9. Processing illustrated in B in FIG. 8 is followed by B in FIG. 10. In addition, in FIG. 8 to FIG. 10, the same symbol is assigned to the same configuration as the configuration described in FIG. 1 to FIG. 7, and the description thereof will be omitted. FIG. 8 to FIG. 10 are sequence diagrams for explaining an operation when a packet addressed to the node C 800 is transmitted from the node A 600 to the input port 210 in the I/O port A 200.

As illustrated in FIG. 8, when the packet addressed to the node C 800 has been transmitted to the input port 210 in the I/O port A 200 (OP1), the data crossbar destination decoder 212a receives the transmitted packet (OP2).

The data crossbar destination decoder 212a decodes the transmitted packet (OP3), and determines that the destination of the transmitted packet is the node C 800.

The data crossbar destination decoder 212a notifies the selector/buffer control unit 212b of the destination information of the packet (OP4).

The selector/buffer control unit 212b receives the destination information of the packet from the data crossbar destination decoder 212a (OP5).

The selector/buffer control unit 212b determines whether the I/O port C counter 213b value is greater than or equal to the threshold value of the capacity of the I/O port A buffer 423a notified by the register 212c (OP6).

In a case where the value of the I/O port C counter 213b is smaller than the threshold value of the capacity of the I/O port A buffer 423a notified by the register 212c (OP6: NO), the selector/buffer control unit 212b issues an instruction to the selector 211b in the input buffer unit 211 to select the bypass path 211d and transmit a packet (OP21). In other words, the selector/buffer control unit 212b determines that there is a free space in the I/O port A buffer 423a in the output port 420.

From the selector/buffer control unit 212b, the input buffer unit 211 receives an instruction to select the bypass path 211d using the selector 211b and transmit a packet (OP22). The selector 211b in the input buffer unit 211 selects the bypass path 211d (OP23), and transmits the transmitted packet through the bypass path 211d.

The selector/buffer control unit 212b issues an instruction to the I/O port C counter 213b to perform addition of the counter value, the I/O port C counter 213b corresponding to the output port of the counter unit 213 given notice of (OP24).

The I/O port C counter 213b receives the addition instruction for the counter value from the selector/buffer control unit 212b (OP25). The I/O port C counter 213b performs addition processing for the counter value (OP26).

The packet addressed to the node C 800 from the node A 600 is transmitted to the input port 210 in the I/O port A 200 (OP27), and the packet is transmitted to the data crossbar 110 through the bypass path 211d (OP28).

On the other hand, in a case where the value of the I/O port C counter 213b is larger than or equal to the threshold value of the capacity of the I/O port A buffer 423a notified by the register 212c (OP6: YES), the selector/buffer control unit 212b issues an instruction to the selector 211b in the input buffer unit 211 to select the buffer bus 211e (OP31). In other words, the selector/buffer control unit 212b determines that there is no free space in the I/O port A buffer 423a in the output port 420. In addition, the selector/buffer control unit 212b issues an instruction to the buffer 211c in the input buffer unit 211 to store a packet at an address where the value of the WP in the counter 212d.

From the selector/buffer control unit 212b, the input buffer unit 211 receives an instruction to select the buffer bus 211e using the selector 211b (OP32). The selector 211b in the input buffer unit 211 selects the buffer bus 211e (OP33).

When the packet addressed to the node C 800 has been transmitted from the node A 600 to the input port 210 in the I/O port A 200 (OP34), the selector 211b in the input buffer unit 211 transmits the packet to the buffer 211c through the buffer bus 211e (OP35). The buffer 211c temporarily stores therein the packet addressed to the node C 800 (OP36).

After having issued the instruction to the selector 211b in the input buffer unit 211 to select the buffer bus 211e (OP31), the selector/buffer control unit 212b issues an instruction to the counter 212d to perform addition (+1) of the WP (OP37).

The counter 212d receives the addition instruction of the value of the WP from the selector/buffer control unit 212b (OP38).

The counter 212d performs addition processing for the value of the WP so as to indicate that a packet has been temporarily stored in the buffer 211c (OP39).

The selector/buffer control unit 212b issues an instruction to the I/O port C counter 213b to perform addition of the counter value, the I/O port C counter 213b corresponding to the output port given notice of (OP40). The I/O port C counter 213b receives the instruction to perform addition of the counter value, from the selector/buffer control unit 212b (OP41).

The I/O port C counter 213b performs addition processing for the counter value in response to the addition instruction from the selector/buffer control unit 212b (OP42).

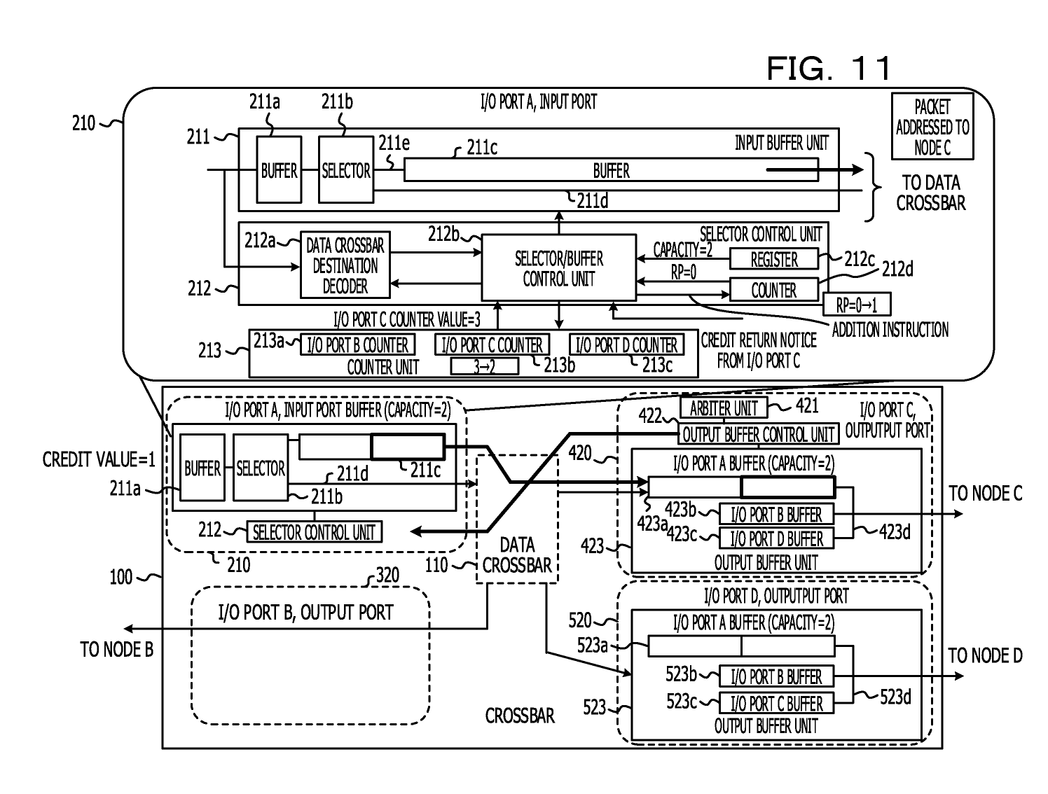

FIG. 11 is a diagram illustrating the operation of the input port 210 in the present embodiment. In addition, in FIG. 11, the same symbol is assigned to the same configuration as the configuration described in FIG. 1 to FIG. 10, and the description thereof will be omitted. FIG. 11 is a diagram for explaining an operation when the input port 210 has received a return notice of a credit from the output port 420.

As illustrated in FIG. 11, the output port 420 in the I/O port C 400 performs credit return notice processing for a packet addressed to the node C 800 with respect to the input port 210 in the I/O port A 200. This credit return notice is a notice indicating that a buffer for storing a packet from the node A 600 has a free space with a packet stored in the I/O port A buffer 423a in the output port 420 had transmitted to the node C 800. This credit return notice is notified to not only the input port 210, but also the node A 600. The number of transmittable packets by the node A 600 is restored depending on the credit return notice, the number of transmittable packets having used by the node A 600 at transmitting of a packet by the node A 600. In addition, FIG. 11 is a diagram for explaining an operation when the credit return notice from the output port 420 is issued depending on transmitting of one packet in the I/O port A buffer 423a from the output port 420 to the node C 800 with the I/O port A buffer 423a stores two packets from the node A 600 and the buffer 211c stores one packet from the node A 600. In FIG. 11, the number of packets (the number of credits) able to be transmitted from the node A 600 is “1”. And, the value of the I/O port C counter 213b is “3” because the I/O port A buffer 423a had stored two packets and the buffer 211c had stored one packet.

The selector/buffer control unit 212b in the input port 210 receives a credit return notice for the packet addressed to the node C 800, from the output port 420.

The selector/buffer control unit 212b compares the threshold value, “2”, of the capacity of the I/O port A buffer 423a notified by the register 212c with the counter value, “3”, received from the I/O port C counter 213b.

From a comparison result, the selector/buffer control unit 212b determines that the value of the I/O port C counter 213b is larger than the threshold value of the capacity of the I/O port A buffer 423a notified by the register 212c. In other words, the selector/buffer control unit 212b determines that a packet addressed to the output port 420 has been temporarily stored in the buffer 211c.

The selector/buffer control unit 212b issues an instruction to the input buffer unit 211 to transmit the packet temporarily stored in the buffer 211c based on the value of the RP in the counter 212d to the output port 420 in the I/O port C 400. The selector/buffer control unit 212b issues an instruction to the I/O port C counter 213b to perform subtraction (−1) of the counter value, the I/O port C counter 213b corresponding to the output port of the counter unit 213. In addition, the selector/buffer control unit 212b issues an instruction to the counter 212d to perform addition (+1) of the value of the RP.

The input buffer unit 211 transmits, to the output port 420, a packet temporarily stored at the RP=0 of the buffer 211c.

Based on the instruction from the selector/buffer control unit 212b, the counter unit 213 performs subtraction (−1) processing for the I/O port C counter 213b.

Based on the instruction from the selector/buffer control unit 212b, the counter 212d performs addition (+1) processing for the value of the RP.

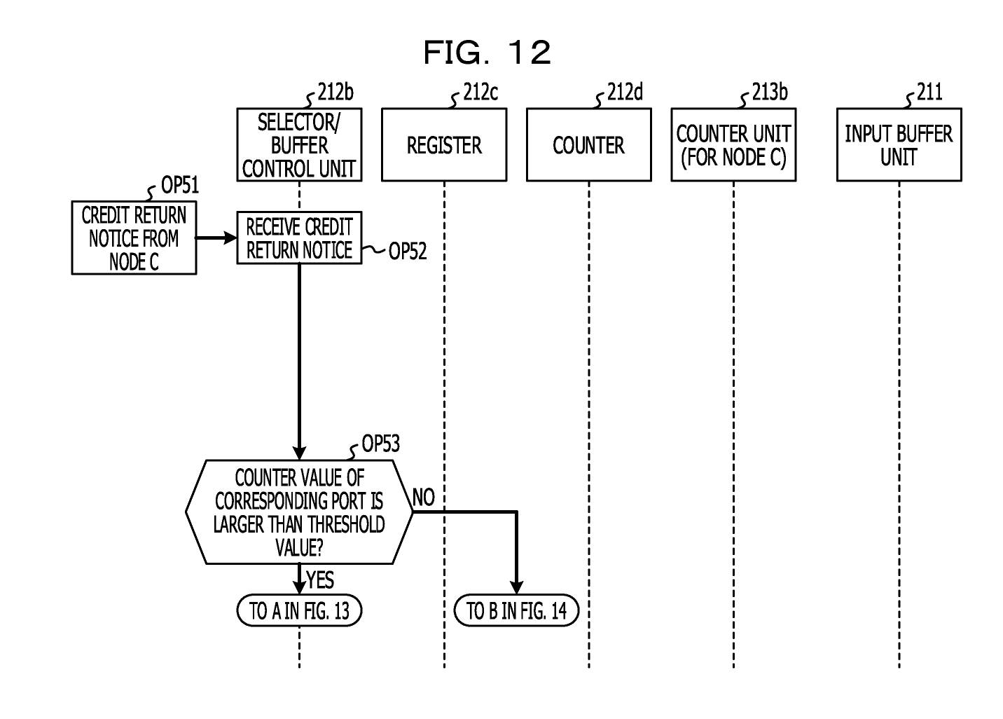

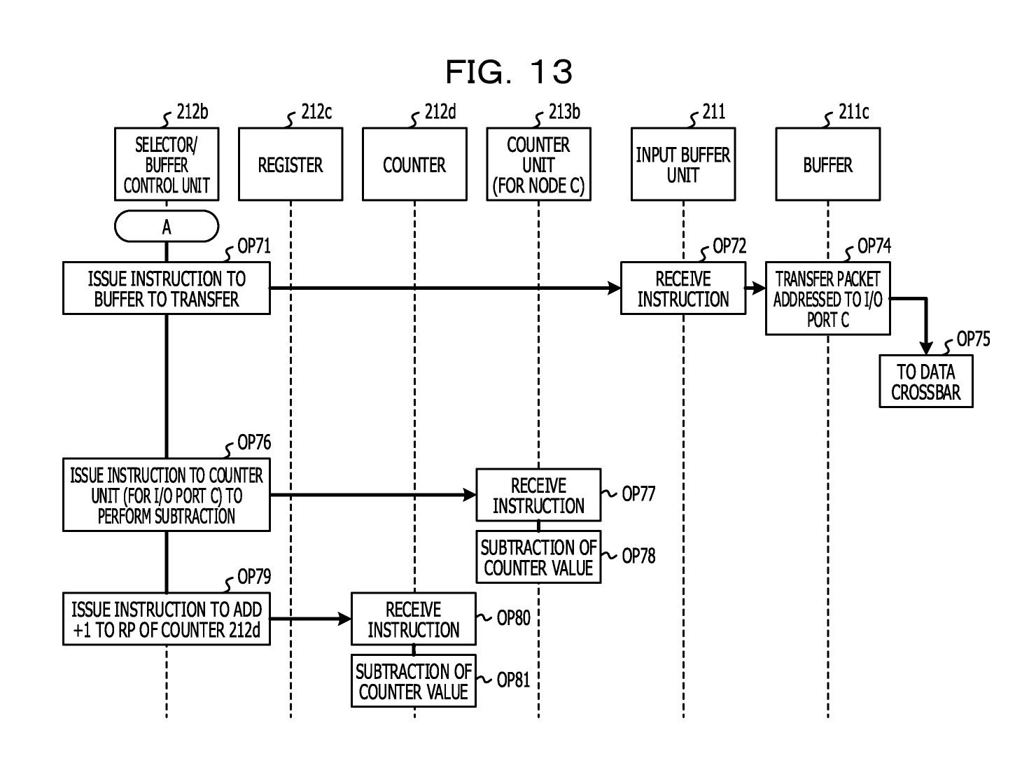

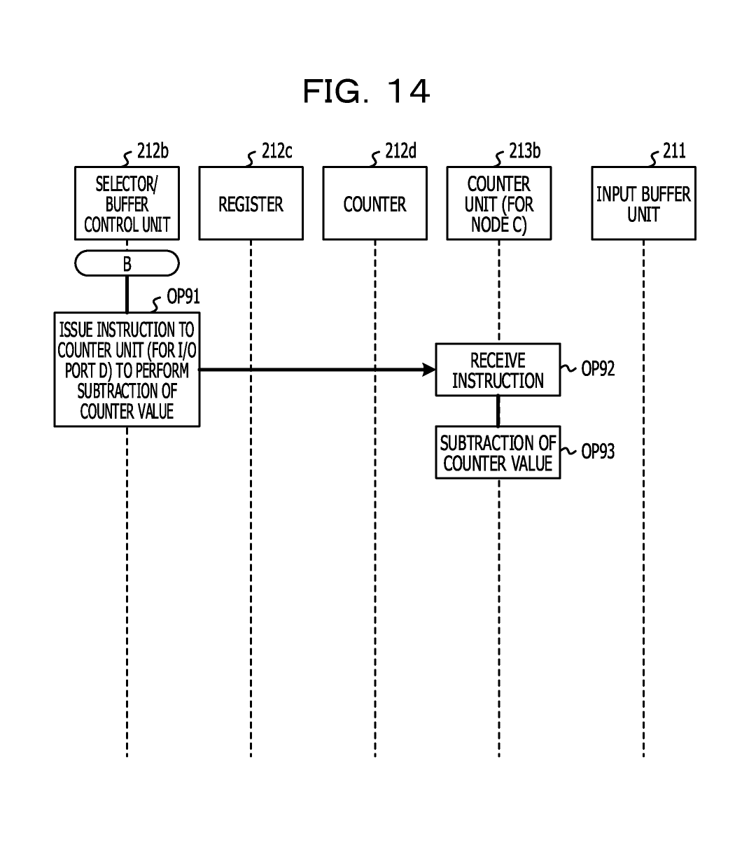

FIG. 12 to FIG. 14 are diagrams illustrating the operation of the input port 210 in the present embodiment. Processing illustrated in A in FIG. 12 is followed by A in FIG. 13. Processing illustrated in B in FIG. 12 is followed by B in FIG. 14. In addition, in FIG. 12 to FIG. 14, the same symbol is assigned to the same configuration as the configuration described in FIG. 1 to FIG. 11, and the description thereof will be omitted. FIG. 12 to FIG. 14 are sequence diagrams for explaining an operation when the input port 210 has received a return notice of a credit from the output port 420.

As illustrated in FIG. 12, the output port 420 in the I/O port C 400 performs credit return notice processing for a packet addressed to the node C 800, with respect to the input port 210 in the I/O port A 200 (OP51).

The selector/buffer control unit 212b in the input port 210 receives a credit return notice for the packet addressed to the node C 800, from the output port 420 (OP52).

The selector/buffer control unit 212b determines whether the value of the I/O port C counter 213b is greater than the threshold value of the capacity of the I/O port A buffer 423a notified by the register 212c (OP53).

In a case where the value of the I/O port C counter 213b is greater than the threshold value of the capacity of the I/O port A buffer 423a notified by the register 212c (OP53: YES), the selector/buffer control unit 212b issues an instruction to the input buffer unit 211 to transmit, to the output port 420 in the I/O port C 400, a packet temporarily stored in the buffer 211c at an address where the value of the RF in the counter 212d (OP71). In other words, the selector/buffer control unit 212b determines that a packet has been temporarily stored in the buffer 211c in the input buffer unit 211.

On the other hand, in a case where the value of the I/O port C counter 213b is less than or equal to the threshold value of the capacity of the I/O port A buffer 423a notified by the register 212c (OP53: NO), the selector/buffer control unit 212b issues an instruction to the I/O port C counter 213b to perform subtraction of the counter value, the I/O port C counter 213b corresponding to the output port of the counter unit 213 given notice of (OP91). In other words, the selector/buffer control unit 212b determines that no packet is stored in the buffer 211c in the input buffer unit 211.

From the selector/buffer control unit 212b, the input buffer unit 211 receives the instruction to transmit, to the output port 420 in the I/O port C 400, the packet temporarily stored in the buffer 211c at the address where the value of the RF in the counter 212d (OP72).

The input buffer unit 211 transmits the packet addressed to the I/O port C 400 temporarily stored in the buffer 211c at the address where the value of the RF in the counter 212d to the output port 420 (OP74). The transmitted packet addressed to the I/O port C 400 is transmitted to the data crossbar 110 (OP75).

The selector/buffer control unit 212b issues an instruction to the I/O port C counter 213b to perform subtraction of the counter value, the I/O port C counter 213b corresponding to the output port of the counter unit 213 (OP76). From the selector/buffer control unit 212b, the I/O port C counter 213b receives the instruction to perform subtraction of the counter value with respect to the I/O port C counter 213b (OP77). The I/O port C counter 213b performs subtraction processing for the counter value with respect to the I/O port C counter 213b (OP78).

The selector/buffer control unit 212b issues an instruction to the counter 212d to perform addition of the value of the RP (OP79). From the selector/buffer control unit 212b, the counter 212d receives the instruction to perform addition of the value of the RP (OP80). The counter 212d performs addition processing for the value of the RP (OP81).

When the selector/buffer control unit 212b has issued an instruction to the I/O port C counter 213b to perform subtraction of the counter value, the I/O port C counter 213b corresponding to the output port of the counter unit 213 given notice of (OP91), the I/O port C counter 213b receives the instruction to perform subtraction of the counter value from the selector/buffer control unit 212b (OP92). The I/O port C counter 213b performs subtraction processing for the counter value (OP93).

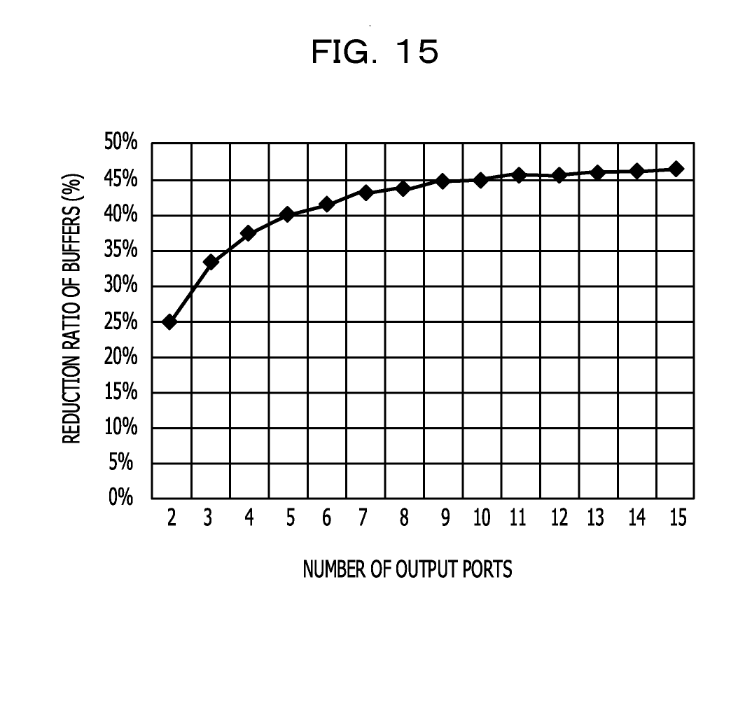

FIG. 15 is a diagram explaining a relationship between the number of output ports and a buffer reduction ratio in the present embodiment. The number of output ports indicates the total number of the output port 220, the output port 320, the output port 420, and the output port 520 the crossbar 100 includes. The buffer reduction ratio indicates the reduction ratio of buffers between a case where buffers used for storing packets are only provided in output ports, described in the technique of the related art, and a case where buffers used for storing packets are provided in input ports and output ports in the present embodiment.

As illustrated in FIG. 15, the buffer reduction ratio in a case where the number of output ports is “2” is 25%. The buffer reduction ratio in a case where the number of output ports is “3” is 33%. The buffer reduction ratio in a case where the number of output ports is “4” is 38%. The buffer reduction ratio in a case where the number of output ports is “5” is 40%. The buffer reduction ratio in a case where the number of output ports is “6” is 42%. The buffer reduction ratio in a case where the number of output ports is “7” is 43%. The buffer reduction ratio in a case where the number of output ports is “8” is 44%. The buffer reduction ratio in a case where the number of output ports is “9” is 44%. The buffer reduction ratio in a case where the number of output ports is “10” is 45%. The buffer reduction ratio in a case where the number of output ports is “11” is 46%. The buffer reduction ratio in a case where the number of output ports is “12” is 46%. The buffer reduction ratio in a case where the number of output ports is “13” is 46%. The buffer reduction ratio in a case where the number of output ports is “14” is 46%. The buffer reduction ratio in a case where the number of output ports is “15” is 47%.

As described above, using the crossbar 100 in the present embodiment, compared with a technique of the related art, the buffer reduction ratio increases with an increase in the number of output ports. In addition, when the capacity of the buffer 211c serving as a type of input buffer is equal to the capacities of the I/O port A buffer 323a, the I/O port A buffer 423a, and the I/O port A buffer 523a that serve as a type of output buffer and each buffer capacity is one-half of the number of packet transmissions able to be transmitted by the node A 600, the buffer reduction ratio becomes highest.

According to the technology disclosed in the present embodiment, the selector control unit 212 serving as a type of control unit issues an instruction to transmit, to the data crossbar 110 serving as a type of crossbar switch, a packet of a destination corresponding to the node A 600 out of packets from the node A 600 serving as a corresponding type of processor after having stored the packet in the buffer 211c serving as a type of input buffer. On the other hand, the selector control unit 212 serving as a type of control unit issues an instruction to transmit, to the data crossbar 110 serving as a type of crossbar switch, a packet of a destination corresponding to the node A 600 serving as a type of processor having no instruction, without storing the packet in the buffer 211c. Therefore, it becomes possible to provide an information processing apparatus and a control method for an information processing apparatus, which are capable of performing efficient transmission of a crossbar without increasing power consumption.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a first processor;
a second processor;
a switch configured to relay a packet transmitted between the first processor and the second processor;
a first output buffer corresponding to the first processor, the first output buffer being configured to store therein a first packet from the first processor, the first packet being addressed to the second processor and received through the switch;
a first input buffer corresponding to the first processor; and
a first selector configured to select one of a first path and a second path, based on a free space of the first output buffer,
wherein
the first path is configured to output the first packet from the first processor, addressed to the second processor, to the switch through the first input buffer when the first packet is input, and
the second path is configured to output the first packet from the first processor, addressed to the second processor, to the switch not through the first input buffer when the first packet is input.

2. The information processing apparatus according to claim 1, wherein
the first selector selects the first path in a case where the free space of the first output buffer falls below at least a predetermined capacity, and selects the second path in a case where the free space of the first output buffer exceeds at least the predetermined capacity.

3. The information processing apparatus according to claim 1, wherein
a capacity of the first input buffer is less than or equal to a capacity of the first output buffer.

4. The information processing apparatus according to claim 1, wherein
a capacity of the first input buffer is equal to a capacity of the first output buffer.

5. The information processing apparatus according to claim 1, further comprising:
a third processor;
a second input buffer provided so as to correspond to the third processor;
a second output buffer provided so as to correspond to the third processor and configured to store therein a second packet from the third processor, the second packet being addressed to the second processor and received through the switch;
a second selector configured to select one of a third path and a fourth path, based on a free space of the second output buffer,
wherein
the third path is configured to output the second packet from the third processor, addressed to the second processor, to the switch through the second input buffer when the second packet is input, and
the fourth path is configured to output the second packet from the third processor, addressed to the second processor, to the switch not through the second input buffer when the second packet is input.

6. The information processing apparatus according to claim 1, wherein
the switch is a crossbar switch.

7. A control method of an information processing apparatus, the information processing apparatus including a first processor, a second processor, a switch configured to relay a packet transmitted between the first processor and the second processor, an output buffer corresponding to the first processor and configured to store therein a packet from the first processor, the packet being addressed to the second processor and received through the switch, and an input buffer, the control method comprising:
receiving the packet from the first processor, addressed to the second processor; and
selecting one of a first path and a second path, based on a free space of the output buffer, so as to transmit the received packet to the switch,
wherein
the first path outputs the received packet to the switch through the input buffer when the received packet is input, and
the second path outputs the received packet to the switch not through the input buffer when the received packet is input.

8. The control method according to claim 7, wherein
a capacity of the input buffer is less than or equal to a capacity of the output buffer.

9. The control method according to claim 7, wherein
a capacity of the input buffer is equal to a capacity of the output buffer.

10. An apparatus comprising:
a first port that includes a first buffer and to which a first processor is coupled;
a second port that includes a second buffer and to which a second processor is coupled; and
a switch to which the first port and the second port are coupled and that relays a packet transmitted between the first processor and the second processor,
wherein the first port further includes
a selector,
a first path that includes the first buffer and couples the selector and an output end of the first port to each other, and
a second path that does not include the first buffer and couples the selector and the output end of the first port to each other,
wherein the selector selects one of the first path and the second path, based on a free space of the second buffer, so as to transmit, to the switch, a packet from the first processor, addressed to the second processor.

11. The apparatus according to claim 10, wherein the apparatus is a crossbar.
